(19) United States
(12) Patent Application Publication
(10) Pub. No.: US 2011/0298206 A1
(43) Pub. Date: Dec. 8, 2011

(54) Electrical Layout System

(76) Inventor: George H. Suddell, Huntington, NY (US)

(21) Appl. No.: 13/019,981

(22) Filed: Feb. 2, 2011

Related U.S. Application Data
(60) Provisional application No. 61/300,632, filed on Feb. 2, 2010.

(51) Int. Cl. B42D 15/00

(52) U.S. Cl. 283/81

(57) ABSTRACT

This invention relates to a layout system, in particular, an electrical layout system designed to increase efficiency and accuracy of marking out on a structure of an electrical circuit from architectural and/or engineering drawings, while simultaneously minimizing the probability of deviation from the drawings when implemented by the installer of the circuitry.

### CROSS REFERENCE TO RELATE PATENT APPLICATIONS

This application claims priority from provisional U.S. Pat. App. No. 61/300,632 filed on 2 Feb. 2010, the contents of which are hereby incorporated by reference and in its entirety.

### BACKGROUND OF THE INVENTION

This invention relates to a layout system, in particular, an electrical layout system designed to increase efficiency and accuracy of marking out on a structure of an electrical circuit from architectural and/or engineering drawings, while simultaneously minimizing the probability of deviation from the drawings when implemented by the installer of the circuitry.

Historically, a contractor or foreman (hereafter foreman) on a given project site would review the architectural and/or engineering drawings and manually mark out on the building structure what specification of hardware, location of the hardware, and connection of the hardware. For example, the foreman would walk about the single family structure once it has been framed, and sheathed, and would mark out on the studs, rafters, etc., where the duplex outlets would be located, where the switches would be located, and where the fixtures would be located, and how each would be interconnected together (i.e., which circuit, amperage, voltage etc.). Sometimes with a marker, pencil, or some other type of writing instrument, wherein a second person (a.k.a. apprentice) would need to search and find the markings, and thereafter hopefully be able to read the foreman's writing and interpret the nomenclature with accuracy. Thereafter, the apprentice would drill the appropriate holes for the wirings according to the markings, and then pull the wire in conformance to the markings (e.g., the proper sized wiring, whether 14 gauge or 12 gauge, type of wiring, e.g., whether Romex or BX, etc.) and then connect the various boxes together in view of the markings, thereby spending considerable time and materials on the markings. One problem with this method is the risk involved with the proper interpretation or decoding by the apprentice of the foreman's handwriting, which is not so bad if the foreman and apprentice are the only two individuals working on a site for the entire project, and have a long standing relationship together. However, it becomes a greater issue when the duration of the relationship is in its infancy, and the number of employees or apprentices increases, and thus the cost of time and materials, inflates exponentially, especially on a commercial job as compared to a single family dwelling. Hence there is a need for an improved system that reduces the risk of improper interpretation of a foreman's nomenclature and an apprentice's implementation thereof, thereby increasing the probability of averting unnecessary waste of time and materials, and monetary penalties for not meeting the completion date, for a plethora of reasons, inter alia, for lack of compliance to building code, or to the terms of the contract schedule, and/or to the specification thereof.

### SUMMARY OF THE INVENTION

The present invention is directed to an electrical layout system having the primary advantage of providing a plurality of preprinted identification labels, each identification label having a menu that the foreman may select a la carte thereon.

One advantage of the present invention is to reduce the likelihood of misinterpretation of the markings.

A second advantage of the present invention is to increase the likelihood that a marking will not be missed, as it is more readily visible to see the label as compared to pencil markings.

A third advantage of the present invention is to increase the likelihood of proper installation of the proper hardware based on actual size and shape of the label.

Other objectives, advantages, and novel features of the present invention will become more apparent from the following detailed description when taken in conjunction with the accompanying drawings.

### BRIEF DESCRIPTION OF THE DRAWINGS

The following drawings, in which like reference characters indicate like parts, are provided for illustration of the invention and are not intended to limit the invention in any manner whatsoever.

FIG. 1 illustrates a first label type of the present invention, namely, a switch label;

FIG. 2 illustrates a second label type of the present invention, namely, an outlet label;

FIG. 3 illustrates a third label type of the present invention, namely, circular box label;

FIG. 4 illustrates a first combination of label types; and

FIG. 5 illustrates a second combination of label types.

### DETAILED DESCRIPTION OF THE INVENTION

The following descriptions of the preferred embodiments are presented to illustrate the present invention and are not to be construed to limit the claims in any manner whatsoever.

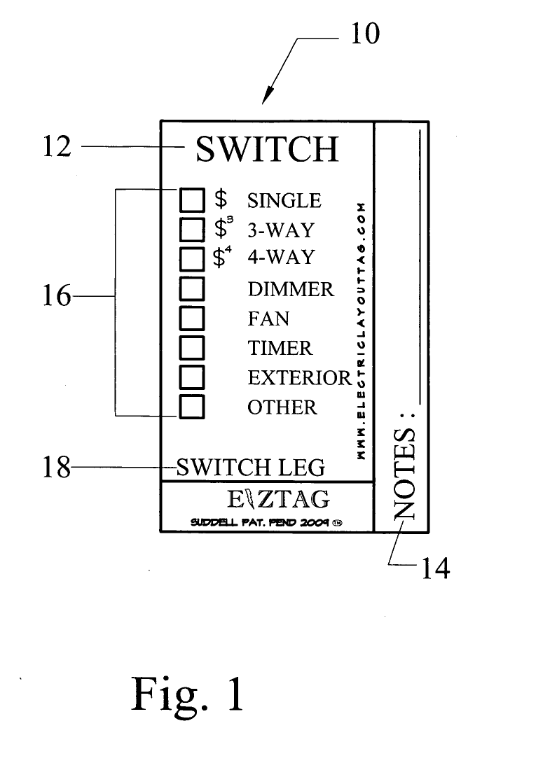

In reference to the drawings, namely FIGS. 1 to 5, illustrate a first embodiment, namely, an electrical layout system 1 comprising: a preprinted identification label, here a switch label 10 having a shape with a size, a title 12, and optionally a space 14 for manually adding notes, wherein said label 10 includes a menu of choices 16. The label 10 is configured and dimensioned with a backing having an adhesive activated backing, although it is envisioned that the label 10 is durable enough to withstand a fastener mounting to a stud, that is, it can be mounted to a stud via a stapling device, such as a staple-hammer, or staple gun, or other commonly used affixation devices, wherein the staple passes through the label 10 into the stud, rafter, or wallboard without substantially damaging the label 10. This first label type 10 has a polygon shape about the same size of an switch/outlet box, whether or not gangable. The label 10 further includes a title 12, here a switch, and optionally, a place to denote which switch leg 18, and a place to denote a selection of the type of switch to be used and/or the purpose via a menu of choices 16: for example, a single, a three-way, a four-way, a dimmer, fan, timer, exterior, and “other” option. It also may provide a space for the amperage of the leg, in addition to a space for notes 14.

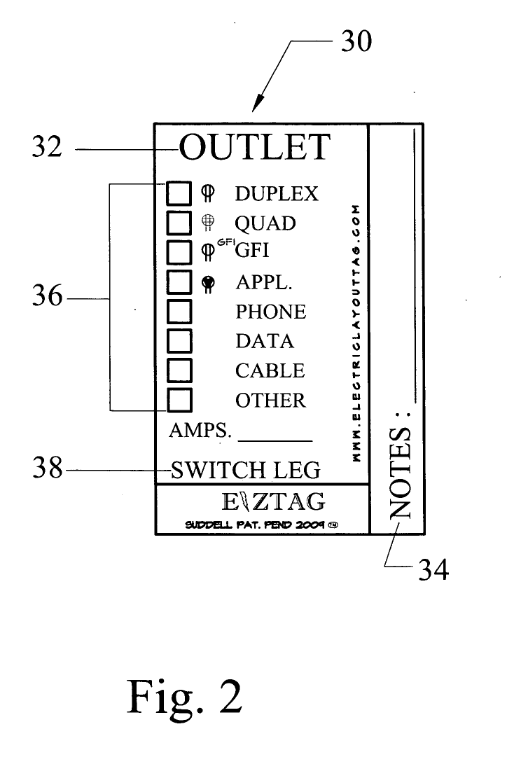

FIG. 2 illustrates an outlet label 30, having a shape with a size, a title 32, and optionally a space for manually adding notes 34, wherein said label 30 includes a menu of choices 36. The label 30 is configured and dimensioned with a backing having an adhesive activated backing, although it is envisioned that the label 30 is durable enough to withstand a fastener mounting to a stud, that is, it can be mounted to a stud via a stapling device, such as a staple-hammer, or staple gun, or other commonly used affixation devices, wherein the staple passes through the label 30 into the stud, rafter, or wallboard. This second label type 30 has a polygon shape about the same size of a rectangular outlet box, whether or not gangable. The label 30 further includes a title 32, here an outlet, and optionally, a place to denote which switch leg 38, and a place to denote a selection via menu choices 36 for example: a duplex, a quad, a GFI, an appliance, a phone, a data, a cable, and other option. It also provides a space for the amperage of the leg, as well as a space for miscellaneous notes 34. In the simplest embodiment, one may have only one outlet box and hence label 30, for example, when running a dedicated line as is often required by local building code for each appliance, such as a 220 volt line for an electric dryer, wherein the only device on the circuit/line is the dryer (appliance). Other embodiments include a plurality of these labels 10, 30 and 50, reflecting the typical combination of switches with outlets of varying in nature.

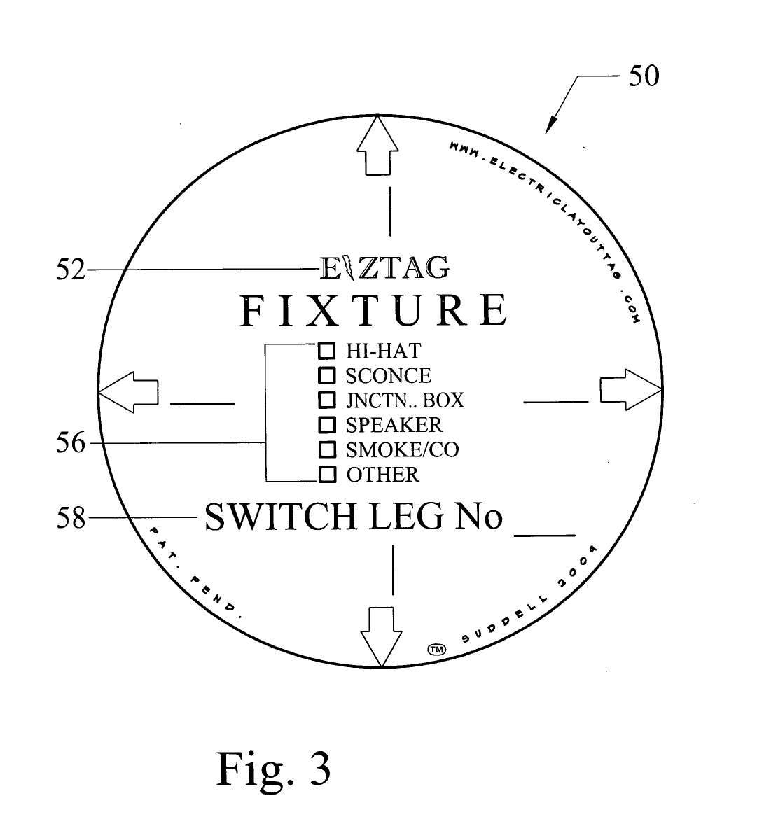

FIG. 3 illustrates another type of label 50, this for a circular box, having a shape with a size, a title 52, and optionally a space for manually adding notes 54, wherein said label 50 includes a menu of choices 56. The label 50 is configured and dimensioned with a backing having an adhesive activated backing, although it is envisioned that the label is durable enough to withstand a fastener mounting to a stud, that is, it can be mounted to a stud via a stapling device, such as a staple-hammer, or staple gun, or other commonly used affixation devices, wherein the staple passes through the label 50 into the stud, rafter, or wallboard without substantially damaging the label 50. This label 50 has a polygon shape about the same size of a circular outlet box, although it is envisioned that square boxes may also be employed (although not illustrated), whether or not gangable. The label 50 further includes a title 52, here a switch leg, and optionally, a place to denote which switch leg 58, and a place to denote a selection of the type/purpose to be used and/or the purpose via a menu of choices 56: for example, hi-hat, sconce, JEM box, speaker, smoke CO2, and other option. It also may provide a space for the amperage of the leg, in addition to a space for notes 54.

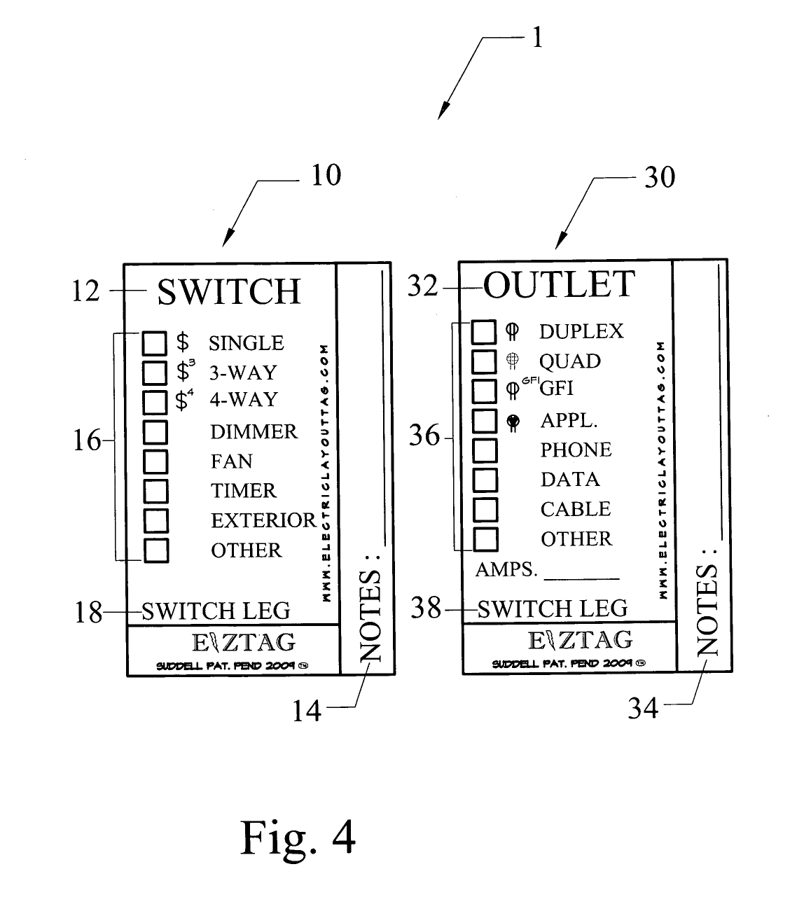

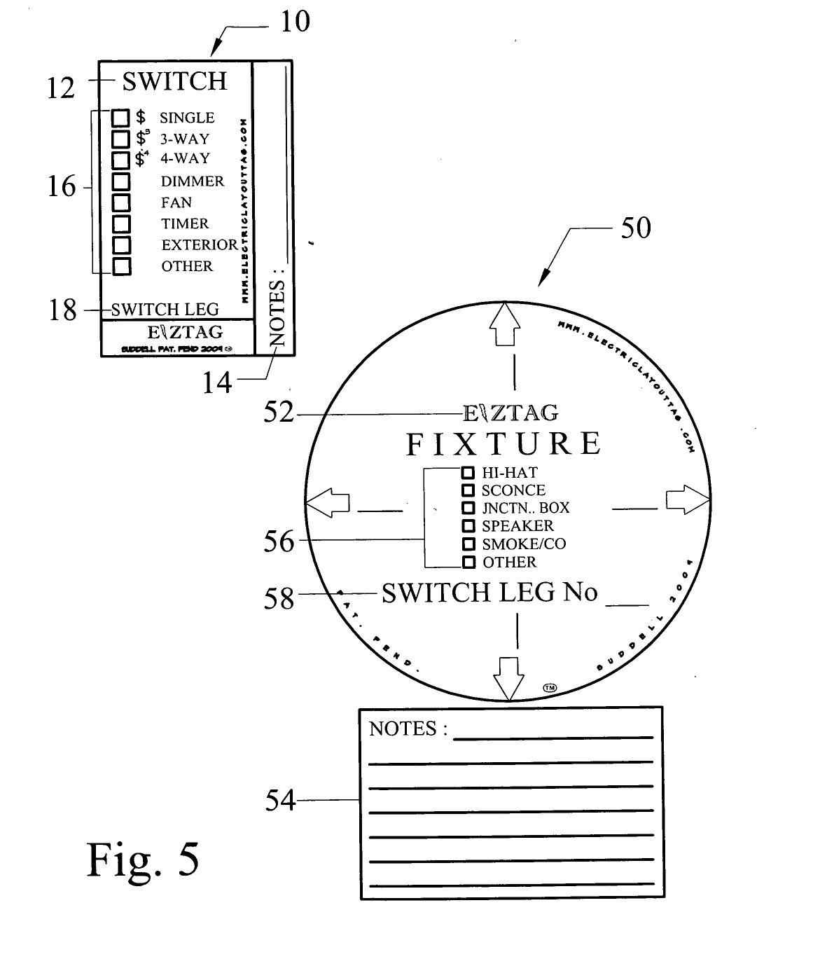

FIG. 4 illustrates the combination of a switch label 10 and an outlet box label 30, FIG. 1 in use with FIG. 2. Wherein FIG. 5 illustrates the combination of a switch label 10 with a circular outlet box label 50, namely FIG. 1 in use with FIG. 3. It envisioned that a switch label 10 can be used in combination with both a rectangular outlet box label 30 of FIG. 2, and with a circular outlet box label 50 of FIG. 3 simultaneously, or even with a plurality of rectangular 30 and/or circular 50 outlet box labels individually or simultaneously.

All of the above referenced patents; patent applications and publications are hereby incorporated by reference. Many variations of the present invention will suggest themselves to those of ordinary skill in the art in light of the above detailed description. All such obvious modifications are within the full-intended spirit and scope of the claims of the present application.

What is claimed is:

1. An electrical layout system comprising:
a plurality of preprinted identification labels having a shape with a size, a title, and optionally a space for manually adding notes, wherein each label includes a menu of choices.

2. The electrical layout system as in claim 1, wherein said labels are configured and dimensioned with a backing having an adhesive activated backing.

3. The electrical layout system as in claim 2, wherein said labels are durable enough to withstand a fastener mounting to a stud.

4. The electrical layout system as in claim 1, wherein a first label type has a shape that is rectangular, wherein the length and width are about the same size of a switch box.

5. The electrical layout system as in claim 4, wherein said first label type includes a title of switch, and place to denote which switch leg, and a place to denote a selection comprising of the following options: a three-way, a four-way, a dimmer, a fan, a timer, exterior, and other.

6. The electrical layout system as in claim 1, wherein a second label type has a shape that is rectangular, wherein the length and width are about the same size of an outlet box.

7. The electrical layout system as in claim 6, wherein said second label type further includes a title of outlet, a place to denote which switch leg, and a place to denote a selection comprising of the following options: a duplex, a quad, a GFI, an appliance, a phone, a data, a cable, and other.

8. The electrical layout system as in claim 1, wherein a third label type has a shape that is circular, having a dimension about the same size of a circular outlet box.

9. The electrical layout system as in claim 8, wherein said third label type further includes a title of outlet, a place to denote which switch leg, and a place to denote a selection comprising of the following options: a hi-hat, a sconce, a JEM box, a speaker, a smoke CO₂, and other.

10. The electrical layout system as in claim 1, wherein each label is installed in the location in the position and orientation of the prospective hardware device.

11. An electrical layout system comprising:
a preprinted identification label having a shape with a size, a title, and optionally a space for manually adding notes, wherein said label includes a menu of choices.

12. The electrical layout system as in claim 11, wherein said label is configured and dimensioned with a backing having an adhesive activated backing.

13. The electrical layout system as in claim 12, wherein said label is durable enough to withstand a fastener mounting to a stud.

14. The electrical layout system as in claim 11, further comprising a first label having a polygon shape about the same size of a switch box, and includes a title of switch, and place to denote which switch leg, and a place to denote a selection comprising of the following options: a three-way, a four-way, a dimmer, a fan, a timer, exterior, and other, and a second label type having a shape that is rectangular, wherein the length and width are about the same size of an outlet box, wherein said second label type further includes a title of outlet, a place to denote which switch leg, and a place to denote a selection comprising of the following options: a duplex, a quad, a GFI, an appliance, a phone, a data, a cable, and other, wherein each label is labeled having the same leg.

15. The electrical layout system as in claim 11, wherein each label is installed in the location in the position and orientation of the prospective hardware device.

16. An electrical layout system comprising:
a preprinted identification label having a shape with a size, a title, and optionally a space for manually adding notes, wherein said label includes a menu of choices.

17. The electrical layout system as in claim 16, wherein said label is configured and dimensioned with a backing having an adhesive activated backing.

18. The electrical layout system as in claim 17, wherein said label is durable enough to withstand a fastener mounting to a stud.

19. The electrical layout system as in claim 16, further comprising a first label having a polygon shape about the same size of a switch box, and includes a title of switch, and place to denote which switch leg, and a place to denote a selection comprising of the following options: a three-way, a four-way, a dimmer, a fan, a timer, exterior, and other, and a second label type having a shape that is circular, having a dimension about the same size of a circular outlet box, wherein said second label type further includes a title of outlet, a place to denote which switch leg, and a place to denote a selection comprising of the following options: a hi-hat, a sconce, a JEM box, a speaker, a smoke CO₂, and other, wherein each label is labeled having the same leg.

20. The electrical layout system as in claim 16, wherein each label is installed in the location in the position and orientation of the prospective hardware device.
